(19) United States
(12) Patent Application Publication
(10) Pub. No.: US 2025/0068662 A1
(43) Pub. Date: Feb. 27, 2025

(54) Privacy-Aware Multi-Modal Generative Autoreply

(71) Applicant: QUALCOMM Incorporated, San Diego, CA (US)

(72) Inventors: Seokeon CHOI, Yongin-si (KR); Juntae LEE, Seoul (KR); Jaewon CHOI, Seoul (KR)

(21) Appl. No.: 18/454,456

(22) Filed: Aug. 23, 2023

(51) Int. Cl. G06F 16/33

(52) U.S. Cl. CPC G06F 16/334

(57) ABSTRACT

Various embodiments include systems and methods for generating a privacy-aware multi-modal autoreply to an incoming communication. A processing system of a computing device may collect multi-modal information, determine a current user circumstance based on the collected information, determine a user privacy preference for autoreply responses, and generate a prompt that is input to a generative large language model (LLM) to generate optional autoreply responses, receive a list of personalized response suggestions from the generative LLM, and perform an autoreply action based on a selected personalized response suggestion.

### BACKGROUND

Autoreply is a feature for generating automated actions or responses in a computer system or software application when a specific event or condition is met (e.g., the receipt of an email or a support request, etc.). Autoreply functions are commonly used in texting applications, email systems, customer support tools, and social media platforms to acknowledge receipt or provide preliminary information while a human responder may be unavailable. These automated responses may include general information, pre-written answers to frequently asked questions, instructions for further action, etc.

In recent years, autoreply has become an important feature in a variety of different platforms and devices, including conventional mobile operating systems such as Android and iOS. Autoreply functionality may aid users in setting up automatic replies to various forms of communication, including phone calls, text messages, or emails. The autoreply feature may be particularly useful in circumstances that prohibit prompt responses to incoming correspondences, such as during meetings, vehicular transit, or in situations where users find themselves in an area devoid of wireless service.

The messages generated by autoreply may be preset, customized, or a blend of both, varying from simple notifications to more detailed explanations. Certain systems incorporate the autoreply function natively within their built-in messaging or email settings, while others might depend on third-party apps available from app stores or software repositories. Once the autoreply feature is engaged, predefined responses may be sent automatically in response to incoming calls or messages. Some platforms offer sophisticated configurations that permit customization of autoreply messages, including the designation of particular contacts for autoreply, specification of unique time periods when autoreply is active, etc.

### SUMMARY

Various aspects include methods that may be implemented in a processing system of a computing device for providing autoreply responses may include collecting multi-modal information regarding a user of the computing device, determining a current user circumstance based on the collected multi-modal information, determining a user privacy preference for autoreply responses, generating a prompt based on selected multi-modal information and the user privacy preferences for autoreply responses and inputting the prompt to a generative large language model (LLM), receiving a list of personalized response suggestions from the generative LLM, receiving a user input selection of one of the received personalized response suggestions responsive to rendering the received personalized response suggestions on an electronic display of the computing device, and performing an autoreply action based on the received user input.

Some aspects may further include activating or deactivating, based on the determined current user circumstance and the determined user privacy preference for autoreply responses, one or more information sub-modules that are configured to receive data inputs and output text suitable for use in prompting the generative LLM. Some aspects may further include processing non-text-based information by at least one of the active information sub-modules to generate text suitable for input to the generative LLM. In some aspects, generating the prompt may include generating the prompt by combining text-based and non-text-based information. In some aspects, the non-text-based information includes descriptions based on audio or video sensor data.

Some aspects may further include selecting a model size used in an information sub-module to process non-text-based information based on one or more of the determined current user circumstance, a context of the incoming communication, or the user privacy preference for autoreply responses.

In some aspects, performing the autoreply action based on the received user input may include generating a privacy-aware multi-modal generative autoreply message based on the received user input, and sending the generated privacy-aware multi-modal generative autoreply message to a computing device that initiated an incoming call or message. In some aspects, determining the user privacy preference for autoreply responses may include determining the user privacy preference for autoreply responses based on information that identifies categories of information that the user permits to be included in an autoreply response based on at least one of a context of an incoming call or message, an originator of the incoming call or message, a current location of the user, or a current activity of the user.

Some aspects may further include providing the user input selection of one of the received personalized response suggestions to a machine learning module to enable improving the generation of prompts based on selected multi-modal information and the user privacy preferences for autoreply responses.

Further aspects may include a computing device having a processor configured with processor-executable instructions to perform various operations corresponding to the methods summarized above. Further aspects may include a non-transitory processor-readable storage medium having stored thereon processor-executable instructions configured to cause a processor to perform various operations corresponding to the method operations summarized above. Further aspects may include a computing device having various means for performing functions corresponding to the method operations summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating an example computing system that may be configured to implement some embodiments.

FIGS. 2A and 2B are component block diagrams illustrating components in a computing system configured to generate a privacy-aware multi-modal generative autoreply in accordance with some embodiments.

FIG. 3 is a process flow diagram illustrating am method of generating a privacy-aware multi-modal generative autoreply in accordance with some embodiments.

FIG. 4 is a component block diagram illustrating an example computing device suitable for use with various embodiments.

FIG. 5 is a component block diagram illustrating an example wireless communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The embodiments include computing devices configured to automatically generate personalized responses based on privacy-level settings. A computing device may be configured to perform an analysis of the current situation of a user of the computing device (e.g., the device user's current circumstances, etc.) based on diverse privacy-aware multi-modal information collected from various information sources and sensors within the device to generate various candidate responses to the incoming communication. The computing device may determine a current context of an incoming communication as well as the current activity and situation of the user by analyzing the collected multimodal information. Computing device may use this context information in combination with user privacy settings to generate a suitable prompt for input to a generative Large Language Model (LLM) to generate multiple optional responses.

To prepare context and other user information for use in generating a prompt for the generative LLM, the computing device may use a number of information processing sub-modules that received as input sensor or text information and output text in a prompt that is suitable for input to the generative LLM. The term “sub-module” is used herein to refer to subsystems of the computing device and/or to specialized programs executing in a processing system configured to analyze specific types of data or information, and generate outputs that are in a format suitable for input to the generative LLM. Some information sub-modules may be configured to receive information from text based sources, such as memory, formatting such text commission into a format that is suitable for use in generating prompts for the generative LLM. Other information sub-modules may be configured to receive non-textual data, such as sensor data (e.g., cameras, microphones, accelerometers, etc.) and interpret the data to generate text based output suitable for input to the generative LLM. Interact with one another and/or other components within the computing system to provide or implement high-level functions.

Some nonlimiting examples of some of the modules that may be used in various embodiments include: a visual understanding sub-module that is configured to recognize scenes or objects in camera imagery and generate descriptive text; a speech recognition sub-module configured to receive sounds from a microphone, recognize speech and generate text (i.e., perform speech-to-text transcriptions); a sound processing sub-module configured to receive sounds from the microphone and generate text that describes the background sounds; an electrocardiogram (ECG) analysis sub-module that is configured to receive ECG data from a sensor (e.g., a user's smartwatch) and generate text that describes a user condition indicated by ECG data; and a motion analysis sub-module that is configured to process accelerometer and gyroscope information from an inertial measurement unit (IMU) within the computing device and generate text describing motions or activities of the user.

In various embodiments, the computing device may include a model controller that is configured to determine the context of an incoming communication and the user's activities, access user privacy settings or preferences, and then control which of the various information sub-modules provide outputs to the generative LLM. The model controller may be configured to limit the types of information that the generative LLM uses to generate a list of proposed responses based on the user privacy preferences and informed by the context incoming communication and the user's circumstances. By the model controller enabling or disabling access to information sources provided by the probation sub-modules, the generative LLM may be controlled to generate a list of proposed personalized autoreply messages that are appropriate to the circumstances and consistent with the user's privacy preferences settings. Various embodiments may provide a comprehensive and flexible autoreply solution that readily adapts to a wide variety situations and contexts consistent user privacy preferences/settings.

The term “computing device” may be used herein to refer to any one or all of personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smartwatch, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “processing system” is used herein to refer to systems including one more processors, including multi-core processors, that are organized and configured to perform various computing functions. A processing system may include at least one memory, interface circuitry, and other components integrated into a system. In a processing system, one or more of the processors may be configured to perform one or more operations of various embodiment methods.

The term “system on chip” (SoC) is used herein to refer to a single integrated circuit (IC) chip that contains multiple processors, at least one memory and supporting resources, which may form a processing system integrated on a single substrate. A SoC may contain circuitry for digital, analog, mixed-signal, and radio-frequency functions. A single SoC processing system also may include any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC processing system may include an applications processor that operates as the SoC's main processor, a central processing unit (CPU), a microprocessor unit (MPU), an arithmetic logic unit (ALU), etc. SoC processing systems also may include software for controlling integrated resources and processors, as well as for controlling peripheral devices.

The term “system in a package” (SIP) may be used herein to refer to a single module or package that contains a processing system including multiple resources, computational units, cores, or processors on two or more IC chips, substrates, or SoCs. For example, a SIP processing system may include a single substrate on which multiple IC chips or semiconductor dies are stacked vertically. Similarly, the SIP processing system may include one or more multi-chip modules (MCMs) on which multiple ICs or semiconductor dies are packaged into a unifying substrate. A SIP processing system also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

Autoreply is a feature in modern computing devices for generating automated responses or actions in a computer system or software application when a specific event or condition is met (e.g., receiving an email or a support request, etc.). Autoreply solutions may improve the user experience by allowing an action to be performed (e.g., a message to be sent, etc.) without disrupting an existing call. Various embodiments improve computing devices by improving the responsiveness and flexibility of autoreply solutions consistent with the context of an incoming communication, user activities and user privacy preferences settings. Various embodiments further improve computing devices by learning over time how to generate proposed autoreply responses that satisfy user preferences.

Autoreply solutions may support both message-based and non-message-based responses and actions. A non-message-based response/action may include blocking calls from a specific phone number or allowing a user to press a quit button to reject an incoming call. A message-based response/action may allow the user to choose from a list of optional text messages to send to a caller when they are engaged in another call. For example, the autoreply system may select from template response messages such as “Can't talk, text me” or “I will call you right back.” Some systems may also allow users to craft and register custom messages in advance, such as “I am driving now” or “I am in a meeting.”

Conventional autoreply solutions do not adequately allow for personalized or detailed actions or messages. For example, using conventional solutions, the suggested texts may be pre-composed by the user, software, or network provider, and saved in memory. Consequently, autoreply messages are often generic because they are crafted to be applicable in a wide variety of possible situations. For example, during an urgent meeting, a template message such as “I will call you right back” may not adequately convey the situation's gravity. Custom messages, although offering some adaptability, still may not cover every possible scenario.

A similar feature in some software systems (e.g., MICROSOFT OUTLOOK®, etc.) may generate suggestions for concise responses as soon as a reply is initiated. For example, the suggestions may be generated by an artificial intelligence (AI) system analyzing the primary subject of the incoming email and producing a suggested response based on the words in the email. These systems may be constrained to the content of the incoming email and may not be suitable for use in generating responses that are tailored to the individual user, the particular situation, or the privacy preferences of the user.

Various embodiments include computing devices (e.g., smartphones, tablets, laptop computers, etc.) having a processing system executing an advanced interaction system (AIS) component that gathers information regarding the user from various device sensors and memory. Information from such a AIS may be processed by a model controller to determine the type of information that will be provided to a generative LLM to automatically generate a menu of personalized response suggestions for incoming communications (e.g., calls, texts, emails, etc.) that are responsive to the context of the communication, current user activities and user privacy preferences. In some embodiments, the model controller may be configured to selectively limit access of the generative LLM to information sources and information sub-modules so that the generative LLM generates suggested responses based on the context of the incoming communication, the user's current circumstances, multi-modal information collected in the computing device, and the user's privacy preferences or settings for autoreply responses.

In some embodiments, the model controller that is configured to enable or inhibit the generative LLM's access to the collected multi-modal information, such as activating or deactivating various information sub-modules, based on or responsive to user privacy preferences or settings (e.g., to the user's selected privacy level, etc.). In some embodiments, the model controller may determine the user privacy settings during an incoming call, text, or email (optionally through a user menu) for each distinct category of user information. In some embodiments, the user privacy settings may also be pre-configured for each distinct category of user information. In some embodiments, user privacy preferences or settings for autoreply responses may include or identify categories of information that the user permits to be included in an autoreply response, with the preferences or settings specified for or based on at least one of a context of the incoming call or message, an originator of the incoming call or message, a current location of the user, and/or a current activity of the user. In this manner, the user can specify in advance the types of information that may be included in autoreply responses depending on who is calling/messaging, what the message is about, what is happening with the user at the time, and other criteria that a user may include in privacy preferences.

In some embodiments, the model controller may be configured to detect an incoming communication, determine or retrieve user privacy settings, select information sources and/or information sub-modules outputs based on the user privacy settings, generate LLM query information (e.g., a prompt for the generative LLM) based on the selected information sources, send the LLM query information to a generative LLM to generate a list or collection of proposed customized responses that comply with the user privacy settings, render the proposed customized responses on an electronic display, and allow the user to select one of the rendered proposed customized responses. The computing device may then send the selected proposed customized response as an autoreply message and/or use the selected proposed customized response as feedback to an machine learning system or module to learn user preferences over time.

In some embodiments, the AIS component may be configured to determine, characterize, represent and/or store the user's current circumstances as an information structure (e.g., UserCircumstances, etc.) that includes symbols or numeric values that represent a combination of multi-modal information (e.g., sensor information, location information, calendar insights, etc.).

In some embodiments, the AIS component may be configured to collect multi-modal information from any or all of a variety of sensors, information sub-modules, and memory in the computing device. Examples of multi-modal information that may be collected in the device include sensor information, identification information, operating mode information, location information, calendar insights, audio-visual data, motion data, health data, connectivity information, data network activity information, system resource usage information, state information, driver statistics, hardware component information, software application information, transmission information, etc.

In some embodiments, the AIS component and/or the model controller may be configured to determine the user's current circumstances based on the collected multi-modal information. For example, the AIS component and/or the model controller may be configured to detect a triggering event (e.g., incoming call, text, email, etc.), collect multi-modal information, determine the user's current circumstance based on the collected multi-modal information, and provide the collected or determined information to the model controller. The model controller may be configured to use the received information and user privacy preferences/settings two determine which sources of information should be provided to the generative LLM for generating a list or collection of personalized response suggestions. Proposed customized responses received from the LLM may be rendered on an electronic display for selection by a user. The processing system of computing device may receive a user selection (e.g., touch on a touchscreen display of one of the proposed responses), and perform an action based on the selected response, such as block the caller, send the selected response as an autoreply message, use the selected response to formulate and generate the autoreply message, or similar actions.

In some embodiments, the AIS component, the model controller or another module executing in the processing system of the computing device may also use a user-selected customized response as feedback to a machine learning system to able the model controller to learn user preferences for generating customized responses, and its over time learn to better satisfy the user with proposed autoreply responses. In some embodiments, the AIS component may control and finetune the information inputs to the generative LLM in alignment with user expectations and privacy controls.

In some embodiments, the model controller may be configured to select and/or exclude outputs provided by the various information sub-modules and/or multi-modal information sources based on user privacy settings. For example, the model controller may be configured to use the user privacy settings to determine the information sources and/or information sub-modules that are appropriate for use in generating customized responses under various contexts and circumstances responsive to user privacy preferences, and provide only the selected multi-modal information to the generative LLM for generating proposed autoreply responses.

In some embodiments, the AIS component may be configured to provide the user the option to set privacy levels for different information categories and/or to generate proposed responses that comply with the user-selected privacy levels or settings. Examples of privacy levels include anonymous level, public level, acquaintance level, professional level, friend level, and family level.

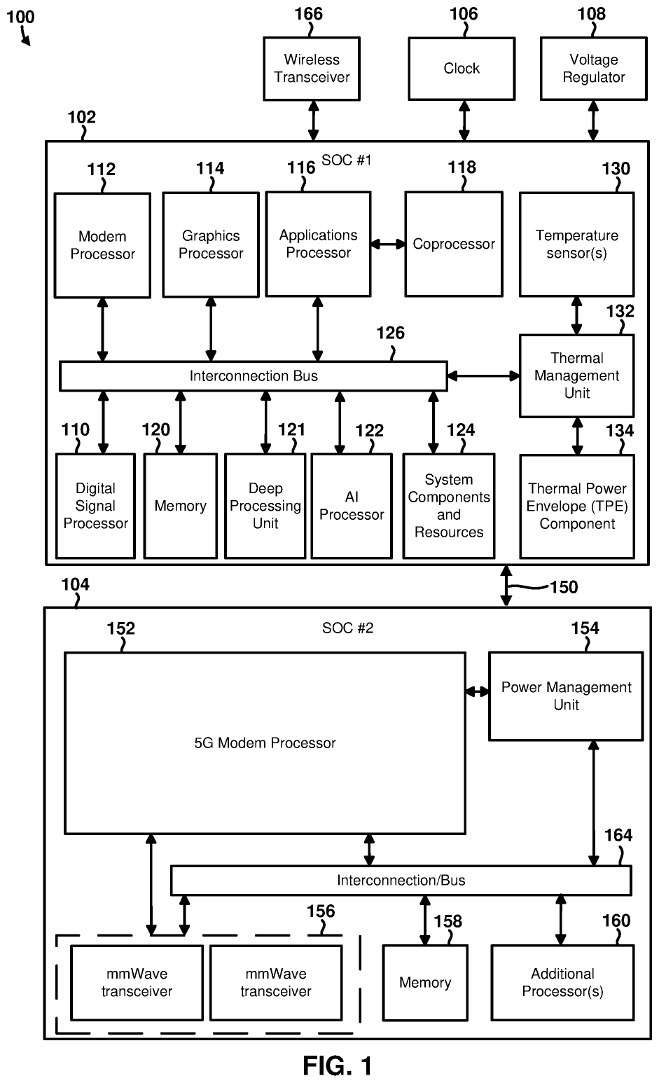

Various embodiments may be implemented in a processing system of the computing device that may include a number of single-processor and multiprocessor computer systems, SoC processing system or an SIP processing system. FIG. 1 illustrates an example SIP processing system 100 architecture that may be used in mobile computing devices implementing various embodiments.

With reference to FIG. 1, the illustrated example SIP processing system 100 includes two SOC processing systems 102, 104, a clock 106, a voltage regulator 108, and a wireless transceiver 166. The first and second SOC processing system 102, 104 may communicate via interconnection bus 150. The various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, at least one memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In some embodiments, the first SOC processing system 102 may operate as the central processing unit (CPU) of the mobile computing device that carries out the instructions of software application programs by performing the arithmetic, logical, control and input/output (I/O) operations specified by the instructions. In some embodiments, the second SOC processing system 104 may operate as a specialized processing unit. For example, the second SOC processing system 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC processing system 102 may include a digital signal processor (DSP) 110, a modem processor 112, a graphics processor 114, an application processor 116, one or more coprocessors 118 (e.g., vector co-processor) connected to one or more of the processors, at least one memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC processing system 104 may include a 5G modem processor 152, a power management unit 154, an interconnection bus 164, a plurality of mmWave transceivers 156, at least one memory 158, and various additional processors 160, such as an applications processor, packet processor, etc.

Each processor 110, 112, 114, 116, 118, 121, 122, 121, 122, 152, 160 in a processing system 100, 102, 104 may include one or more cores, and each processor/core may perform operations independent of the other processors/cores. For example, the first SOC processing system 102 may include a processor that executes a first type of operating system (e.g., FreeBSD, LINUX, OS X, etc.) and a processor that executes a second type of operating system (e.g., MICROSOFT WINDOWS 11). In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC processing system 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC processing system 102 may include power amplifiers, voltage regulators, oscillators, phase-locked loops, peripheral bridges, data controllers, memory controllers, system controllers, Access ports, timers, and other similar components used to support the processors and software clients running on a mobile computing device. The system components and resources 124 may also include circuitry to interface with peripheral devices, such as cameras, electronic displays, wireless communication devices, external memory chips, etc.

The first and/or second SOC processing systems 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SIP processing system 100 discussed above, various embodiments may be implemented in a wide variety of computing systems, which may include a single processor, multiple processors, multicore processors, or any combination thereof.

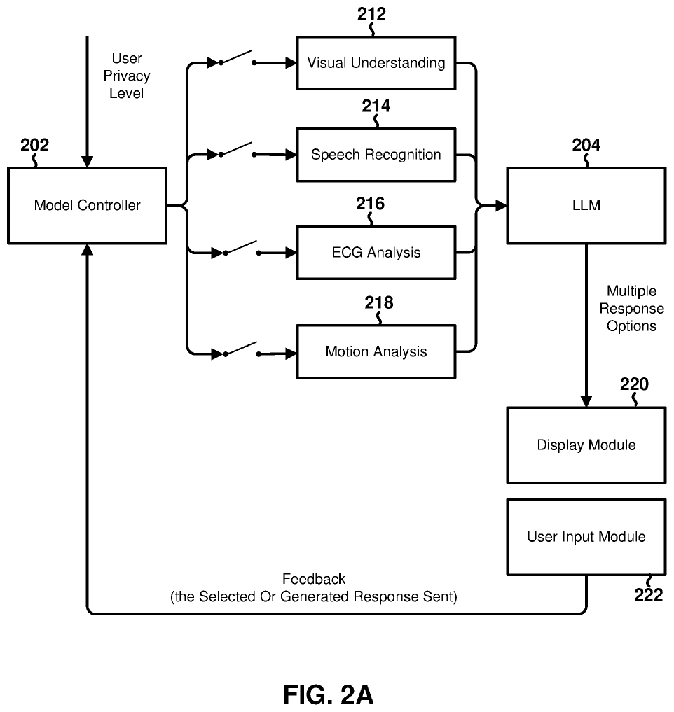

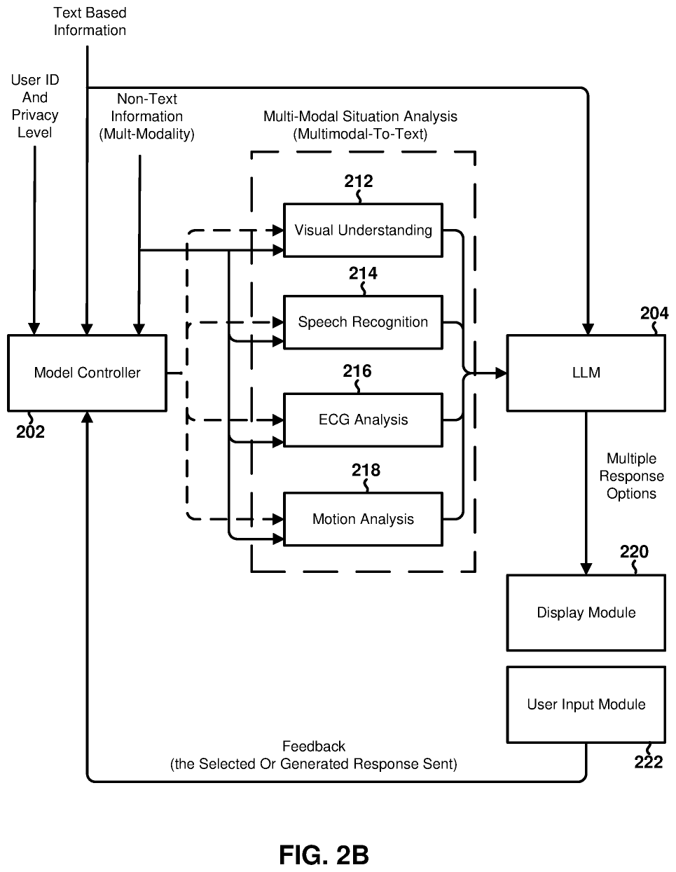

FIGS. 2A and 2B illustrate logical configurations of example components in a computing system (e.g., SIP processing system 100, SOC processing system 102, etc.) suitable for implementing various embodiments. With reference to FIG. 1-2B, the computing system may include a model controller 202, a LLM 204 component (e.g., a generative LLM), a visual understanding 212 sub-module, a speech recognition 214 sub-module, an electrocardiogram (ECG) analysis 216 sub-module, a motion analysis 218 sub-module, display module 220, and user input module 222. Functionality of the model controller 202 and the various information sub-modules 212-218 may execute in processing system, such as processing systems 100, 102, 104 described with reference to FIG. 1.

The model controller 202 may operate as a gatekeeper limiting the outputs of information sub-modules 212-218 and other data sources that are provided to the LLM 204 for generating multiple suggested autoreply responses. The model controller 202 may be configured to analyze the multi-modal information to determine the context of the incoming communication and the user's situation, and control access by the generative LLM to the information sub-modules 212-218 (e.g., by activating or deactivating selected sub-modules) and other sources of information responsive to the user's privacy preferences or settings for autoreply responses.

The model controller 202 may be configured to receive as input a user ID and privacy preferences/settings that indicate the categories of data that may be used for a user. The model controller 202 may also collect or receive multi-modal data, which may include text-based and non-text information. In some embodiments, the model controller 202 may determine the sub-modules 212-218 that should be activated to filter the collected information, and use gating to activate or deactivate the determined sub-modules so that output of the model controller 202 flows through the activated sub-modules 212-218 to the LLM 204. The LLM 204 may generate response suggestions based on the received outputs of the sub-modules 212-218.

The model controller 202 may also collect or receive text-based and non-text information stored in memory of the computing device and/or received from various sensors on or coupled to the computing device. In some embodiments, the model controller 202 may receive information via the sub-modules 212-218. Examples of text-based information include user location (from GPS), contact data (name, relationship with user), calendar data (upcoming events and meetings), connection data (Bluetooth, Wi-Fi status), and user's current activity (from operating system information). Examples of non-text information include environmental data (e.g., sound data from microphone, visual data from camera systems, etc.) and user's health data (e.g., from a smartwatch, etc.). Generally, text-based information may be transmitted to the LLM 204 without further analysis. On the other hand, non-text information (e.g., received from various sensors) may require analysis and conversion into text before input to the LLM 204. Various sub-modules 212-218 may perform such additional multi-modal analysis operations to convert non-text information into a format that is suitable for use as input into the LLM 204.

In some embodiments, the various information sub-modules 212-218 may include more than one model, with different models having different sizes or computational capabilities. Models of different sizes may capable of analyzing different volumes of information. In such embodiments, the model controller 202 may be configured to determine an appropriate model (e.g., an appropriate model size) within each activated sub-module in view of the determined circumstances, the nature of the incoming message or phone call, the source of the incoming message or phone call, etc. For example, activating a small model in the visual understanding 212 sub-module may result in the system analyzing only the types of objects that are present in an image, which may be applicable for responding to some incoming messages. Activating a larger model may cause the system to use image captioning technology to generate extensive text that explains the relationships between objects in the image that may be appropriate for providing a detailed response to an incoming message. For example, in response to determining that information that can be generated by the visual understanding 212 sub-module is important for prompting the LLM 204 in the current context, the model controller 202 may activate a large visual processing model in the visual understanding sub-module 212 to perform a more robust visual analysis of the data and send additional information to the LLM 204.

In some embodiments, the model controller 202 may be configured to operate in rule-based mode (without learning) or as a small LLM. In the rule-based mode, the model controller 202 may open specific model gates based on predefined situations. Different individuals may desire different responses in the same situation and the privacy level of the desired responses may vary for the same person depending on the specific situation. For example, user privacy preferences may specify categories of information that the user permits to be included in autoreply responses that depend on variables such as a context of the incoming call or message, the originator of the incoming call or message, and the location and/or current activity of the user. As such, the model controller 202 may use machine learning techniques to learn from feedback related to the generated text from the LLM 204 and the user's selected responses, thereby improving the selective access of the LLM to different information sources and information processing sub-modules 212-218 based on the incoming communication, the user's situation and the individual's preferences.

The visual understanding sub-module 212 may be configured to analyze visual information an generate text describing some aspects of the imaged scene. For example, the visual understanding 212 sub-model may perform image recognition, which may include classifying objects, people, animals, etc. in the images. The visual understanding 212 sub-model may conduct semantic segmentation, which may include analyzing the detailed pixels of the images to identify the location and boundaries of different object classes. The visual understanding 212 sub-model may also use image captioning, in which the visual understanding 212 sub-model considers objects, backgrounds, and their relationships within the image, to generate more meaningful textual descriptions suitable for input to the LLM 204.

The speech recognition sub-module 214 may be configured to decode and interpret auditory signals, translate spoken words into text, facilitate voice-controlled interactions, etc., translating such information into text format. For example, the speech recognition sub-module 214 may be configured to recognize and analyze audio information from the device's microphone, analyze the input audio signal, and convert the audio information into text descriptions based on the analysis. The speech recognition sub-module 214 may transcribe the audio or determine the current situation based on the input sound (e.g., identify the speaker, analyze the speaker's emotions or mood, etc.). Similarly, a sound recognition sub-module (not shown separately) may be configured to analyze sounds received by microphone to determine the nature of background sounds and generated text description of the environmental sounds picked up by the microphone.

The ECG analysis sub-module 216 may be configured to interpret and evaluate electrical signals corresponding to the user's heart activity, provide insights into the user's health or emotional state, etc., and translate the sensor data into information in a form (e.g., text) that can be received and processed by the LLM 204. Such ECG analysis may be conducted through smartwatches or other specialized electrical devices, enabling the analysis of electrical signals. The ECG analysis sub-module 216 may also be configured to allow for the understanding of the heart's electrical signals, enabling the calculation of heart rate and the detection of abnormalities associated with different cardiac conditions.

The motion analysis sub-module 218 may be configured to evaluate motion sensor data (e.g., physical movements captured through accelerometers, gyroscopes, etc.) and translate the sensor data into information into a form (e.g., text) that can be received and processed by the LLM 204. For example, the motion analysis sub-module 218 may analyze the user's motion based on the motion information received through a smartwatch or other electronic devices. The motion analysis sub-module 218 may determine whether the user is moving or stationary based on the movement data. The motion analysis 218 sub-model may analyze the user's specific actions or activities based on their motion patterns.

The LLM 204 component may be configured to receive a prompt input from the model controller 202 and/or selected information sub-modules 212-218 and use the prompt to generate a list of proposed personalized responses that are responsive to the collated multi-modal information, the user's current context our activities, and user privacy preferences or settings for autoreply responses. The LLM 204 component may receive text inputs generated by the model controller 202 and/or selected information sub-modules 212-218 based on the results of the gathered, analyzed, converted, and filtered text-based and non-text information from the model controller 202. The LLM 204 may analyze the received information to generate several nuanced and personalized responses that effectively take into account the user's current circumstances and privacy settings.

The display module 220 may be configured to render the proposed personalized responses and accept a user input selecting a preferred autoreply response option. For example, the display module 220 may be a touchscreen display, such as on a smart phone.

The user input module 222 may be configured to receive and process the user selections or inputs, which may be fed back into the system for continuous refinement and learning.

As an example, the processing system may receive specific user privacy preferences/settings as input, which may be stored in memory. The processing system may use the user privacy preferences/settings inputs to make decisions regarding selectively enabling or disabling LLM access to (e.g., by selectively activating or deactivating) various information sub-modules 212-218 based upon the user privacy settings as well as the context of the incoming communication and current user activities. For example, the user inputs may include user privacy settings that set the permissions for Location, Calendar, Camera, and Microphone set to “ON,” and set the permissions for Bluetooth, Health, ECG, and Motion set to “OFF.” In response, the model controller 202 may cause the data that is sent to the LLM 204 to include outputs from sub-modules 212-218 provide text related to the user's location, upcoming calendar events, visual information from the camera, and auditory data from the microphone, and exclude information from Bluetooth connections, health monitors, ECG sensors, and motion detectors.

As another example, the model controller 202 may be configured to determine the data that is relevant to an incoming communication. The model controller 202 may handle multimodal data, without any feedback, additional training, or updating. The model controller 202 may determine the data that is used for multi-modal analysis based on user privacy preferences or settings for autoreply responses. Text-based information (e.g., the location information indicating that the user is in the “A203 building,” calendar information indicating “academic seminar from 10 AM to 11 AM”, etc.) may be sent to the LLM 204 component without extensive processing or analysis. The model controller 202 and/or sub-modules 212-218 may perform multi-modal analysis on non-text information (e.g., visual and sound data from the microphone and camera, etc.) to convert the non-text information into a suitable text format for input into the LLM 204. The LLM 204 may analyze the visual and auditory data in conjunction with text-based inputs such as location and calendar events to generate contextually relevant responses that adhere to the user's privacy settings.

In some embodiments, model controller 202 may collect and filter multimodal information from different sub-modules based on user privacy preferences/settings to create a robust context-aware understanding of the user's context. By selecting different filtering mechanisms based on user privacy settings, the model controller 202 may control the information that is used to generate the proposed responses. For example, the visual understanding 212 sub-module may determine that there is a lack of visual input or an all-black screen and that this is likely due to the computing device being placed in the user's pocket. In response, the visual understanding 212 sub-module may generate the text “No visual information detected” that is sent to the LLM 204 component. On the other hand, the speech recognition sub-module 214 may detect the speaker's voice and analyze it to understand that the speaker is currently giving a presentation. Based on this auditory data, the LLM 204 may generate a proposed autoreply as “Multiple individuals, including the owner of the phone, are engaged in a conversation, and the topic of the conversation is related to deep learning.”

In some embodiments, the system may combine text-based and non-text information to generate a comprehensive understanding that enables the LLM 204 component to generate diverse response options that are relevant to an incoming communication and responsive to the user's current situation and respectful of the user's privacy preferences. Generated autoreply response options may range from generic responses to highly detailed responses that reflects all relevant available information. For example, text-based information such as location details (“A203 building”) and a calendar event (“academic seminar from 10 AM to 11 AM”) may be combined with non-text information such as visual understanding (“No visual information detected.”) and speech recognition (“Multiple individuals, including the owner of the phone, are engaged in a conversation, and the topic of the conversation is related to deep learning.”). In response to such inputs, the LLM 204 component may generate nuanced response options, ranging from a generic response that doesn't utilize any specific information to highly detailed responses that incorporate all available data. Examples of such options may include: “I am currently unable to take a call” “I am currently in the A203 building, so I'll contact you later” “I am currently in the A203 building, attending an academic seminar from 10 AM to 11 AM. I'll contact you later,” “I am currently in the A203 building, attending an academic seminar from 10 AM to 11 AM. My phone is in my pocket, so I can't check it now. I'll contact you later”, and “I am currently in the A203 building, attending an academic seminar from 10 AM to 11 AM. My phone is in my pocket, and I am currently conversing with multiple people about deep learning. I'll contact you later.”

In some embodiments, the model controller may be re-trained based on specific responses selected by the user to generate better response options for subsequent incoming communications. This retraining may be performed repeatedly or continually so as to fine-tune operations and better align with the user's preferences and/or to improve the performance of the autoreply functionality. For example, some users might prefer to share a large amount of information in particular situations, while others may prefer more restrictive sharing of personal information. As such, the model controller could activate both the visual understanding and speech recognition sub-modules to analyze information collected by the camera and microphone in response to determining based on calendar and location data that the device user is participating in a meeting. The model controller may send the collected information to the LLM, present the user with options, and evaluate the selected option to determine whether to activate more sub-modules 212-218 or use larger models to provide more detailed information or to deactivate modules and use smaller models to minimize resource usage.

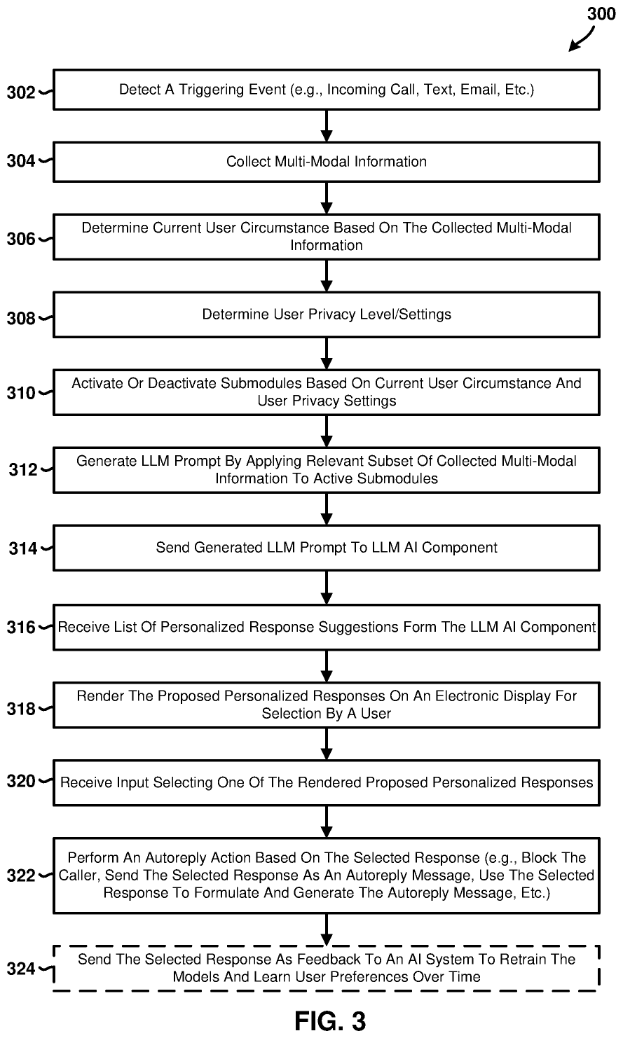

FIG. 3 illustrates a method 300 of performing an autoreply in a computing device in accordance with some embodiments. With reference to FIGS. 1-3, operations of the method 300 may be performed in a computing device by a processing system (e.g., 100, 102, 104) that may include one or more processors (e.g., processors 110, 112, 114, 116, 118, 121, 122, 121, 122, 152, 160, etc.), components, or subsystems (e.g., model controller 202, sub-modules 212-218, LLM 204, etc.) as described. Further, one or more processors within a processing system may be configured with software or firmware to perform various operations of the method. To encompass any of the processor(s), hardware elements and software elements that may be involved in performing the method 300, the elements performing method operations are referred to generally as a “processing system.” Means for performing the functions of the method 300 may include a processing system (e.g., 100, 102, 104) including one or more processors (e.g., processors 110, 112, 114, 116, 118, 121, 122, 121, 122, 152, 160, etc.), components, or subsystems (e.g., model controller 202, sub-modules 212-218, LLM 204, etc.) described herein.

In block 302, the processing system may detect a triggering event, such as incoming call, text, email, etc. For example, the processing system may detect an incoming call by monitoring the telecommunication network's signaling information or detect incoming texts or emails by checking for new messages on specific applications or subsystems. The processing system may also be configured to recognize other triggering events, such as calendar alerts or reminders, by interacting with scheduling and time-management applications.

In block 304, the processing system may collect multi-modal information relevant to the user from a plurality of information sources on or accessible by the computing device. For example, the processing system may collect sensor information from embedded sensors that measure attributes such as location, movement, temperature, pressure, etc. The processing system may collect location information from global navigation satellite system (GNSS) modules (e.g., Global Positioning System (GPS) modules) that pinpoint the device's geographical position. The processing system may collect calendar insights from scheduling applications, collect audio-visual data from microphones and cameras, collect motion data from accelerometers, collect health data from health-monitoring components such as heart rate sensors, and collect connectivity information, data network activity information, system resource usage information, etc. through corresponding hardware and software components that monitor and control these subsystems in the computing device. The processing system may also collect user information stored in memory, such as the user's age, sex, marital status, education level, employment status, employer, and the like. By aggregating a variety of multi-modal information, the processing system may build a nuanced understanding of the user's current circumstance and allow for more personalized and context-aware interactions.

In block 306, the processing system may determine current user circumstances based on the collected multi-modal information. For example, the processing system may combine sensor readings, location data, calendar insights, motion information, and connectivity details, to determine the user's context. As a more detailed example, the processing system may use location information combined with calendar data to determine that the user is currently in a scheduled meeting. The processing system may use motion data and sensor information to determine whether the user is currently driving, running or walking. The processing system may use connectivity information to determine whether the device is connected to a home or office network, and thus whether the user is currently located in the home or office.

In block 308, the processing system may determine user privacy preferences/settings. In some embodiments, the processing system may determine the user privacy level based on a user identifier and/or user inputs that identify categories of data that may be used for the user. In some embodiments, user privacy preferences or settings for autoreply responses may be stored in memory, and a processing system may determine user privacy preferences/settings by accessing that memory. In some embodiments, user privacy preference for autoreply responses include information that identifies categories of information that the user permits to be included in an autoreply response based on or responsive to the context of the incoming call or message, the originator of the incoming call or message, the current location of the user, or the current activity of the user. In some embodiments, the processing system may determine the user privacy level based on any or all of user preferences, pre-configured settings, and contextual analyses. For example, the user may define privacy levels across different information categories, select preferences for various conditions or features such as location sharing, access to personal data, or communication permissions. The user may set such preferences for different individuals, contexts or relationships, such as spouse, family, professional, or public privacy preferences. In addition, the processing system may allow users to pre-configure privacy settings for distinct categories of information, providing granular control over what is shared with whom. The processing system may also dynamically adjust privacy settings based on the user's current circumstances and/or based on predefined rules or user behavior patterns.

In block 310, the processing system executing the model controller functionality may enable or disable access by the generative LLM to information sources, such as by selectively activating or deactivating information sub-modules based on current user circumstances and user privacy preferences or settings for autoreply responses. For example, if the user privacy settings permit location, calendar, camera, and microphone data to be included in autoreply responses, but restrict the disclosure of Bluetooth, health, ECG, and motion data in autoreply responses, the processing system may selectively activate the information sub-modules corresponding or relating to the permitted information categories and deactivate the information sub-modules related to the restricted information categories. In some embodiments, the complexity of analysis and/or size of the language models within each information sub-module may be selected based on current user circumstances and user privacy settings. In some embodiments, activating or deactivating the information sub-modules may include using a selective gating mechanism in the computing device.

In block 312, the processing system may generate a prompt that is suitable for input to the generative LLM by applying a relevant subset of collected multi-modal information to active information sub-modules. For example, the processing system may apply a relevant subset of collected multi-modal information, including both text-based and non-text-based data, to active information sub-modules. As part of these operations, the processing system may filter and/or direct the collected information through the activated information sub-modules. The processing system may process the non-text-based information, such as audio or video data, through specialized information sub-modules designed for auditory or visual analysis. For example, an audio understanding sub-module may interpret spoken words or background sounds, and a visual understanding sub-module may analyze objects and relationships within a video or image, and generate text suitable for any LLM prompt.

In block 314, the processing system may input the generated prompt to the generative LLM. In various embodiments, the processing system may send the LLM prompt to an generative LLM hosted locally within the device or to add LLM service host remotely on a server. For example, after generating the LLM prompt by applying both text-based and non-text-based information to the active sub-modules within the computing device, the processing system may package the resulting output as an LLM prompt that is transmitted to the generative LLM. This transmission could be facilitated through a secure communication channel that ensures data integrity and confidentiality. In response to receiving the prompt, the generative LLM may generate a list of personalized response suggestions based on the input.

In block 316, the processing system may receive a list of personalized response suggestions from the generative LLM. The list of personalized response suggestions may include a variety of nuanced response options, ranging from a generic response that doesn't utilize any specific information to highly detailed responses that incorporate all available data. Examples of such options may include: “I am currently unable to take a call” “I am currently in the A203 building, so I'll contact you later” “I am currently in the A203 building, attending an academic seminar from 10 AM to 11 AM. I'll contact you later,” “I am currently in the A203 building, attending an academic seminar from 10 AM to 11 AM. My phone is in my pocket, so I can't check it now. I'll contact you later”, and “I am currently in the A203 building, attending an academic seminar from 10 AM to 11 AM. My phone is in my pocket, and I am currently conversing with multiple people about deep learning. I'll contact you later.”

In block 318, the processing system may render the proposed personalized responses on an electronic display for selection by a user. The rendering operations may include converting the received suggestions into a format suitable for visual presentation and organizing them in a user-friendly interface. The processing system may display the responses in a list, grid, or other visually appealing layout, accompanied by interactive elements that allow the user to easily select a desired response.

In block 320, the processing system may receive input that selects one of the rendered proposed personalized responses. For example, a user may select an option through a touchscreen interface by tapping on the desired response, or through a mouse click when using a desktop or laptop. The user input may also be voice commands or gestures.

In block 322, the processing system may perform an autoreply action based on the selected response (e.g., block the caller, send the selected response as an autoreply message, use the selected response to formulate and generate the autoreply message, etc.). For example, if the selected response is to block a caller, the processing system may update a blocking list or engage specific call control features to prevent further communication from that number. If the selected option is to send an autoreply message, the processing system may automatically formulate a text or multimedia message based on the selected response, and send it to the original caller/sender through an appropriate channel (e.g., SMS, email). The processing system may also use the selected response as a basis to generate a more elaborate autoreply message that integrates additional information or tailors the content to the selected option. The processing system may also use templates, scripting, or further processing by generative LLM and/or AI components to perform autoreply actions. In some embodiments, the processing system may perform autoreply actions based on predefined rules, user preferences, and/or real-time context.

In some embodiments, in block 322 the processing system may use the user's privacy preference for autoreply responses in view of the context and originator of the incoming message or call to generate a privacy-aware multi-modal generative autoreply message based on the received user input, and send the generated privacy-aware multi-modal generative autoreply message to a computing device that initiated an incoming call or message.

In optional block 324, the processing system may send the selected response as feedback to a machine learning module to support the training of the model controller so as to learn user preferences over time. This feedback or retraining loop may be a part of an adaptive system that continually refines and personalizes the system's behavior and recommendations. For example, the processing system may analyze the specific responses the user selects over time, and identify patterns, preferences, and/or tendencies that reflect the user's behavior and decision-making. The processing system may use any or all such information to adjust or retrain the models within the system. For example, if a user consistently selects certain types of responses for specific scenarios, the machine learning system could learn to prioritize or recommend similar responses in future interactions.

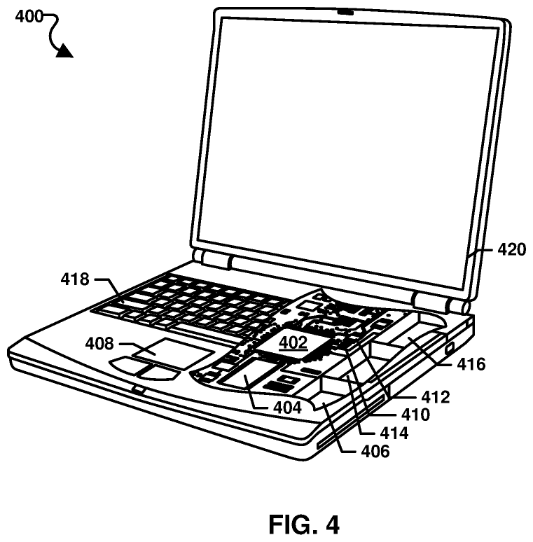

Various embodiments (including, but not limited to, embodiments described above with reference to FIGS. 1-3) may be implemented in a wide variety of wireless devices and computing systems including a laptop computer 400, an example of which is illustrated in FIG. 4. With reference to FIGS. 1-4, a laptop computer may include a processor 402 coupled to at least one memory, such as volatile memory 404 and a large capacity nonvolatile memory, such as a disk drive 406 of Flash memory. The laptop computer 400 may include a touchpad touch surface 408 that serves as the computer's pointing device, and thus may receive drag, scroll, and flick gestures. Additionally, the laptop computer 400 may have one or more antenna 410 for sending and receiving electromagnetic radiation that may be connected to a wireless data link and/or cellular telephone transceiver 412 coupled to the processor 402. The computer 400 may also include a BT transceiver 414, a compact disc (CD) drive 416, a keyboard 418, and a display 420 all coupled to the processor 402. Other configurations of the processing system may include a computer mouse or trackball coupled to the processor (e.g., via a Universal Serial Bus (USB) input) as are well known, which may also be used in conjunction with various embodiments.

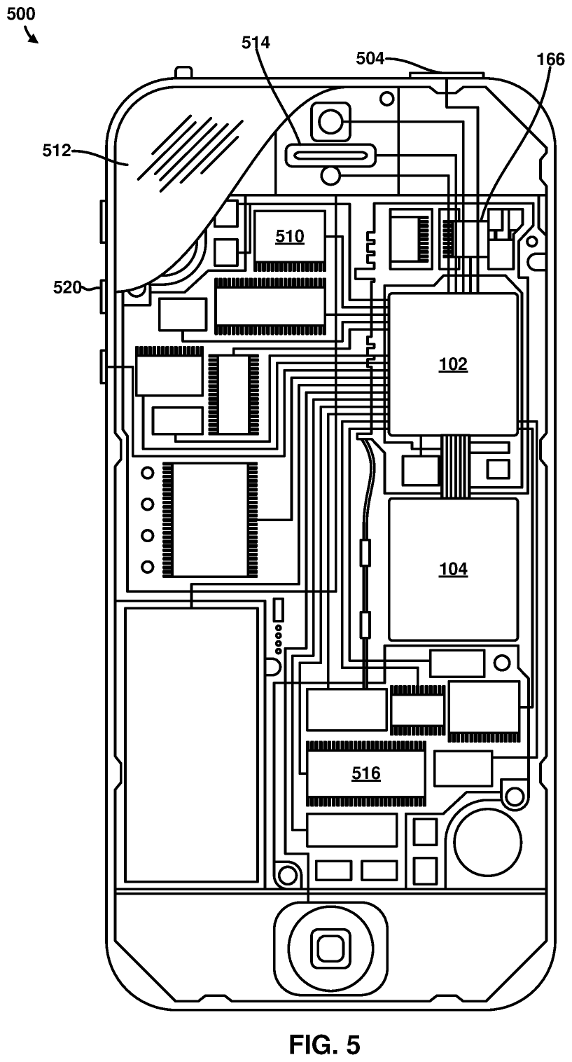

FIG. 5 is a component block diagram of a computing device 500 suitable for use with various embodiments. With reference to FIGS. 1-5, various embodiments may be implemented on a variety of computing devices 500, an example of which is illustrated in FIG. 5 in the form of a smartphone. The computing device 500 may include a first SOC processing system 102 coupled to a second SOC processing system 104. The first and second SoC processing systems 102, 104 may be coupled to at least one internal memory 516, a display 512, and to a speaker 514. The first and second SOC processing systems 102, 104 may also be coupled to at least one subscriber identity module (SIM) 540 and/or a SIM interface that may store information supporting a first 5GNR subscription and a second 5GNR subscription, which support service on a 5G non-standalone (NSA) network.

The computing device 500 may include an antenna 504 for sending and receiving electromagnetic radiation that may be connected to a wireless transceiver 166 coupled to one or more processors in the first and/or second SOC processing systems 102, 104. The computing device 500 may also include menu selection buttons or rocker switches 520 for receiving user inputs.

The computing device 500 also includes a sound encoding/decoding (CODEC) circuit 510, which digitizes sound received from a microphone into data packets suitable for wireless transmission and decodes received sound data packets to generate analog signals that are provided to the speaker to generate sound. Also, one or more of the processors in the first and second processing systems 102, 104, wireless transceiver 166 and CODEC 510 may include a digital signal processor (DSP) circuit (not shown separately).

The processing system and included processors or processing units may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in memory before they are accessed and loaded into processors of the processing system. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including at least one memory coupled to at least one processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of performing autoreply responses by a processing system of a computing device, including: collecting multi-modal information regarding a user of the computing device; determining a current user circumstance based on the collected multi-modal information; determining a user privacy preference for autoreply responses; generating a prompt based on selected multi-modal information and the user privacy preferences for autoreply responses and inputting the prompt to a generative large language model (LLM); receiving a list of personalized response suggestions from the generative LLM; receiving a user input selection of one of the received personalized response suggestions responsive to rendering the received personalized response suggestions on an electronic display of the computing device; and performing an autoreply action based on the received user input.

Example 2. The method of example 1, further including activating or deactivating, based on the determined current user circumstance and the determined user privacy preference for autoreply responses, one or more information sub-modules that are configured to receive data inputs and output text suitable for use in prompting the generative LLM.

Example 3. The method of example 2, further including processing non-text-based information by at least one of the active information sub-modules to generate text suitable for input to the generative LLM.

Example 4. The method of example 3, in which generating the prompt includes generating the prompt by combining text-based and non-text-based information.

Example 5. The method of example 3, in which the non-text-based information includes descriptions based on audio or video sensor data.

Example 6. The method of example 1, further including selecting a model size used in an information sub-module to process non-text-based information based on one or more of the determined current user circumstance, a context of the incoming communication, or the user privacy preference for autoreply responses.

Example 7. The method of example 1, in which performing the autoreply action based on the received user input includes: generating a privacy-aware multi-modal generative autoreply message based on the received user input; and sending the generated privacy-aware multi-modal generative autoreply message to a computing device that initiated an incoming call or message.

Example 8. The method of example 1, determining the user privacy preference for autoreply responses includes determining the user privacy preference for autoreply responses based on information that identifies categories of information that the user permits to be included in an autoreply response based on at least one of a context of an incoming call or message, an originator of the incoming call or message, a current location of the user, or a current activity of the user.

Example 9. The method of example 1, further including providing the user input selection of one of the received personalized response suggestions to a machine learning module to enable improving the generation of prompts based on selected multi-modal information and the user privacy preferences for autoreply responses.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in or by a vehicle's advanced driver assistance system (ADAS), system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a processing system that may include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of performing autoreply responses by a processing system of a computing device, comprising:
collecting multi-modal information regarding a user of the computing device;
determining a current user circumstance based on the collected multi-modal information;
determining a user privacy preference for autoreply responses;
generating a prompt based on selected multi-modal information and the user privacy preferences for autoreply responses and inputting the prompt to a generative large language model (LLM);
receiving a list of personalized response suggestions from the generative LLM;
receiving a user input selection of one of the received personalized response suggestions responsive to rendering the received personalized response suggestions on an electronic display of the computing device; and
performing an autoreply action based on the received user input.

2. The method of claim 1, further comprising activating or deactivating, based on the determined current user circumstance and the determined user privacy preference for autoreply responses, one or more information sub-modules that are configured to receive data inputs and output text suitable for use in prompting the generative LLM.

3. The method of claim 2, further comprising processing non-text-based information by at least one of the active information sub-modules to generate text suitable for input to the generative LLM.

4. The method of claim 3, wherein generating the prompt comprises generating the prompt by combining text-based and non-text-based information.

5. The method of claim 3, wherein the non-text-based information includes descriptions based on audio or video sensor data.

6. The method of claim 1, further comprising selecting a model size used in an information sub-module to process non-text-based information based on one or more of the determined current user circumstance, a context of the incoming communication, or the user privacy preference for autoreply responses.

7. The method of claim 1, wherein performing the autoreply action based on the received user input comprises:
generating a privacy-aware multi-modal generative autoreply message based on the received user input; and
sending the generated privacy-aware multi-modal generative autoreply message to a computing device that initiated an incoming call or message.

8. The method of claim 1, wherein determining the user privacy preference for autoreply responses comprises determining the user privacy preference for autoreply responses based on information that identifies categories of information that the user permits to be included in an autoreply response based on at least one of a context of an incoming call or message, an originator of the incoming call or message, a current location of the user, or a current activity of the user.

9. The method of claim 1, further comprising providing the user input selection of one of the received personalized response suggestions to a machine learning module to enable improving the generation of prompts based on selected multi-modal information and the user privacy preferences for autoreply responses.

10. A computing device, comprising:
at least one memory;
a display; and
a processing system coupled to the at least one memory and the display and comprising one or more processors one or more of which are configured to:
collect multi-modal information regarding a user of the computing device;
determine a current user circumstance based on the collected multi-modal information;
determine a user privacy preference for autoreply responses;
generate a prompt based on selected multi-modal information and the user privacy preferences for autoreply responses and inputting the prompt to a generative large language model (LLM);
receive a list of personalized response suggestions from the generative LLM;
receive a user input selection of one of the received personalized response suggestions responsive to rendering the received personalized response suggestions on the display of the computing device; and
perform an autoreply action based on the received user input.

11. The computing device of claim 10, wherein one or more of the processors of the processing system is further configure to activate or deactivate, based on the determined current user circumstance and the determined user privacy preference for autoreply responses, one or more information sub-modules that are configured to receive data inputs and output text suitable for use in prompting the generative LLM.

12. The computing device of claim 11, wherein one or more of the processors of the processing system is further configure to process non-text-based information by at least one of the active information sub-modules to generate text suitable for input to the generative LLM.

13. The computing device of claim 12, wherein one or more of the processors of the processing system is further configure to generate the prompt by combining text-based and non-text-based information.

14. The computing device of claim 12, wherein the non-text-based information includes descriptions based on audio or video sensor data.

15. The computing device of claim 10, wherein one or more of the processors of the processing system is further configure to select a model size used in an information sub-module to process non-text-based information based on one or more of the determined current user circumstance, a context of the incoming communication, or the user privacy preference for autoreply responses.

16. The computing device of claim 10, wherein one or more of the processors of the processing system is further configure to perform the autoreply action based on the received user input by:
generating a privacy-aware multi-modal generative autoreply message based on the received user input; and
sending the generated privacy-aware multi-modal generative autoreply message to a computing device that initiated an incoming call or message.

17. The computing device of claim 10, wherein one or more of the processors of the processing system is further configure to determine the user privacy preference for autoreply responses based on information that identifies categories of information that the user permits to be included in an autoreply response based on at least one of a context of an incoming call or message, an originator of the incoming call or message, a current location of the user, or a current activity of the user.

18. The computing device of claim 10, wherein one or more of the processors of the processing system is further configure to provide the user input selection of one of the received personalized response suggestions to a machine learning module to enable improving the generation of prompts based on selected multi-modal information and the user privacy preferences for autoreply responses.

19. A computing device, comprising:
means for collecting multi-modal information regarding a user of the computing device;
means for determining a current user circumstance based on the collected multi-modal information;
means for determining a user privacy preference for autoreply responses;
means for generating a prompt based on selected multi-modal information and the user privacy preferences for autoreply responses and inputting the prompt to a generative large language model (LLM);
means for receiving a list of personalized response suggestions from the generative LLM;
means for receiving a user input selection of one of the received personalized response suggestions responsive to rendering the received personalized response suggestions on an electronic display of the computing device; and
means for performing an autoreply action based on the received user input.

20. The computing device of claim 19, further comprising means for activating or deactivating, based on the determined current user circumstance and the determined user privacy preference for autoreply responses, one or more information sub-modules that are configured to receive data inputs and output text suitable for use in prompting the generative LLM.

21. The computing device of claim 20, further comprising means for processing non-text-based information by at least one of the active information sub-modules to generate text suitable for input to the generative LLM.

22. The computing device of claim 21, wherein means for generating the prompt comprises means for generating the prompt by combining text-based and non-text-based information.

23. The computing device of claim 21, wherein the non-text-based information includes descriptions based on audio or video sensor data.

24. The computing device of claim 19, further comprising means for selecting a model size used in an information sub-module to process non-text-based information based on one or more of the determined current user circumstance, a context of the incoming communication, or the user privacy preference for autoreply responses.

25. The computing device of claim 19, wherein means for performing the autoreply action based on the received user input comprises:
means for generating a privacy-aware multi-modal generative autoreply message based on the received user input; and
means for sending the generated privacy-aware multi-modal generative autoreply message to a computing device that initiated an incoming call or message.

26. The computing device of claim 19, wherein means for determining the user privacy preference for autoreply responses comprises means for determining the user privacy preference for autoreply responses based on information that identifies categories of information that the user permits to be included in an autoreply response based on at least one of a context of an incoming call or message, an originator of the incoming call or message, a current location of the user, or a current activity of the user.

27. The computing device of claim 19, further comprising means for providing the user input selection of one of the received personalized response suggestions to a machine learning module to enable improving the generation of prompts based on selected multi-modal information and the user privacy preferences for autoreply responses.

28. A non-transitory processor-readable medium having stored thereon processor-executable instructions configured to cause one or more processors of a processing system of a computing device to perform operations comprising:
collecting multi-modal information regarding a user of the computing device;
determining a current user circumstance based on the collected multi-modal information;
determining a user privacy preference for autoreply responses;
generating a prompt based on selected multi-modal information and the user privacy preferences for autoreply responses and inputting the prompt to a generative large language model (LLM);
receiving a list of personalized response suggestions from the generative LLM;
receiving a user input selection of one of the received personalized response suggestions responsive to rendering the received personalized response suggestions on an electronic display of the computing device; and
performing an autoreply action based on the received user input.

29. The non-transitory processor-readable medium of claim 28, wherein the stored processor-executable instructions are configured to cause one or more processors of the processing system of the computing device to perform operations further comprising activating or deactivating, based on the determined current user circumstance and the determined user privacy preference for autoreply responses, one or more information sub-modules that are configured to receive data inputs and output text suitable for use in prompting the generative LLM.

30. The non-transitory processor-readable medium of claim 28, wherein the stored processor-executable instructions are configured to cause one or more processors of the processing system of the computing device to perform operations further comprising providing the user input selection of one of the received personalized response suggestions to a machine learning module to enable improving the generation of prompts based on selected multi-modal information and the user privacy preferences for autoreply responses.
